(19) United States
(12) Patent Application Publication
(10) Pub. No.: US 2025/0050639 A1
(43) Pub. Date: Feb. 13, 2025

(54) METHOD AND SYSTEM FOR A SELF-MAINTENANCE AND RECOVERY SYSTEM FOR A PRINTHEAD

(71) Applicant: QUANTICA GMBH, Berlin (DE)

(72) Inventors: Ben HARTKOPP, Berlin (DE); Ludwig FÄRBER, Leipzig (DE); David NIEDNER, Berlin (DE)

(21) Appl. No.: 18/719,623

(22) PCT Filed: Nov. 17, 2022
(86) PCT No.: PCT/EP2022/082245

§ 371 Date: Jun. 13, 2024

(30) Foreign Application Priority Data
Dec. 16, 2021 (EP) 21215072.6

(51) Int. Cl. B41J 2/185; B41J 2/16; B41J 2/165

(52) U.S. Cl. CPC B41J 2/16502; B41J 2/1606; B41J 2/16532; B41J 2/185

(57) ABSTRACT

A material removal unit and a material removal method for a printhead. The unit comprising a pass-through opening provided under an ejection opening of the printhead and configured such that an ejected droplet can pass through the pass-through opening essentially without being affected; at least one conduit forming channel configured to form a conduit. Wherein the conduit is communicatively connecting an area surrounding the ejection opening with a connection point configured to remove excess material from the area surrounding the ejection opening. The conduit has at least one conduit opening close to the pass-through opening and is configured to transport the material to the connection point.

The invention relates to a method and system for a self-maintenance and recovery system for a printhead. In particular, the invention relates to method and system for a material removal unit and or material recovery unit for a printhead, preferably for an inkjet-type printhead, preferably for a 3D-printhead.

In this description it is frequently referred to a “printhead”. Such a printhead is described e.g. in EP 3 825 100 A1. All technical details of the printhead and the material ejection system of said application are herewith incorporated by reference. However, the method and system of the present invention is also suitable for any other printhead for liquid material droplets.

It is a problem that in a printhead excess material located in an area close to and/or surrounding an ejection orifice of said printhead, e.g. as shown in FIG. 1, is degrading the ejection quality of the respective ejection orifice.

In a printhead, typically a material ejection orifice ejects a material droplet by an actuation of an actuating member, imparting a physical impulse onto the liquid material present in the printing head.

Said liquid material is forming a meniscus, or in other words, is forming a liquid gas interface at a position controlled by a negative internal pressure. This results in a difference in pressure between the outside of the nozzle containing element and the inside of said nozzle containing element, i.e. a liquid material reservoir.

The meniscus is formed in a position for ideal ejection under normal operation of said printhead. Said meniscus has the potential to protrude in a direction away from the nozzle opening until the gas liquid interface is no longer connected to the nozzle opening and causes a wetting of the surrounding surface around the nozzle opening. This is leading to a pendant drop formation of excess material.

This excess material is impeding the controlled release of further droplets from the ejection orifice, due to an interference of the ejected material and the excess material via surface tension and/or non-uniform kinetic energy transfer, which is degrading the printing performance.

It is thus an object of the present invention to provide a method and system for a self-maintenance and recovery system for a printhead capable of removing excess material and restoring printing performance. The object is achieved by the subject-matter of the independent claims. The dependent claims relate to further aspects of the invention.

According to the invention there is provided a material removal unit for a printhead, the unit comprising: a pass-through opening provided under an ejection opening of the printhead and configured such that an ejected droplet can pass through the pass-through opening essentially without being affected; at least one conduit forming channel configured to form a conduit. Wherein the conduit is communicatively connecting an area surrounding the ejection opening with a connection point configured to remove excess material from the area surrounding the ejection opening. Wherein the conduit has at least one conduit opening close to the pass-through opening and is configured to transport the material to the connection point.

According to an embodiment of the invention, the conduit is configured to be connected to a suction device at the connection point; configured to remove the excess material from the area surrounding the ejection opening; and configured to transport the material in the conduit through a dragging force; and/or wherein a pressure gradient is formed in the conduit when the suction device is connected to the connection point.

According to an embodiment of the invention, the diameter of the pass-through opening is at least essentially equal or preferably greater that a diameter of the corresponding ejection opening of the printhead, and/or the ejection opening is located essentially in the center of the pass-through opening.

According to an embodiment of the invention, wherein the conduit is configured to transport the excess material to a material reservoir; and/or a material reservoir is in communication with the printhead in order to recycle the material in the material reservoir.

According to an embodiment of the invention, a nozzle well is formed in the area surrounding the ejection opening; and the nozzle well is configured to allow a path for material in excess of a predetermined size threshold to be guided to the conduit opening.

According to an embodiment of the invention, an anti-stiction coating is provided in the conduit and/or the area surrounding the ejection opening; and, preferably, the anti-stiction coating is a complete or a micro-structured partial anti-stiction coating.

According to an embodiment of the invention, the anti-stiction coated area is configured to creating an anisotropic ratchet conveyor on the bottom and/or top of the conduit; the conduit is configured to support the ratchet conveyor by vibrations of the printhead; and/or the anti-stiction coating is provided in the shape of curved rungs.

According to an embodiment of the invention, at least two areas with different surface energies are provided around the ejection opening in a half-rounded shape.

According to an embodiment of the invention, additional openings are provided at junction points of the conduit forming channels; and wherein conduit shaping elements are provided in said openings in order to reshape of the conduits formed in the conduit forming element.

According to the invention there is provided a material removal method for a printhead, the method comprising: providing a material removal unit according to any one of aforementioned embodiments; communicatively connecting, with a conduit, an area surrounding the ejection opening with a connection point configured to remove excess material from the area surrounding the ejection opening; and transporting the excess material to the connection point based on at least one transport method; wherein the conduit has at least one conduit opening close to the pass-through opening.

According to an embodiment of the invention, the transport method is based on a pressure gradient in the conduit; and/or based on a ratchet conveyor in the conduit and/or a nozzle well.

It is a core aspect of the present invention to remove said excess material via a negative pressure conduit leading to a continuous restoration of the nozzle ejection.

It is a core aspect of the present invention to provide material removal unit comprising at least one conduit forming element configured to remove excess material from at least one ejection orifice. The conduit forming element is provided on or close to a connecting nozzle containing element of a printhead.

A pressure gradient and/or a drag force are affecting the excess liquid material present in an affected area around said orifice, thereby the excess material is removed, and desired ejection performance is obtained.

Furthermore, it is a core aspect that the material removal unit is connected to a reservoir and thus forms a material recovery unit.

In a primary embodiment of the invention, the problem of removing excess material, while not negatively affecting the ejection of large droplets form the ejection orifice is addressed. This is solved by allowing a large enough distance from the flight path of ejected droplets to the through opening of the conduit forming element. Thereby direct contact of said larger droplets with the conduit forming element is prevented, while still retaining a high efficiency in removing excess material from the nozzle well.

In a secondary embodiment of the invention, the problem of ensuring that the position of an excess amount of material beyond a threshold, at which it can negatively affect the drop ejection performance is addressed. In this embodiment the excess material is transported to a position such that it is not contacting material being ejected from the ejection orifice. The transport is based on the material surface tension and is positioning the material closer to a conduit opening. Thus, the dragging force is increased, which allows for a more effective transport of the excess material to the conduit opening.

In a tertiary embodiment of the invention, the problem of removing an excess material present in the nozzle well is addressed. Excess material present in the nozzle well can result in the release unwanted droplets, thereby negatively impacting printing performance. Excess material present in the nozzle well is neither connected or affected by a surface tension interaction with the ejection orifice or the conduit opening. This is in a first sub-embodiment resolved by utilizing a dragging force emanating from a negative pressure conduit opening which is sucking in ambient gas, whereby said gas introduces a dragging force on the surface of such an excess material, thereby ideally moving it towards the negative pressure conduit opening.

However, if said material cannot be transported to the conduit openings in further sub-embodiments additional effects are utilized to allow the transport of the material. The transport may be based on the use of a remnant vibrational energy originating from the actuator of the printhead or on pressure fluctuations induced by the dragging force. Said vibrations deforming the droplet and causing it to anchor on half rounded structures of differential surface energy areas present on the underside of the nozzle containing element via the use of anti-stiction coatings and non-coated areas. This causes a ratchet conveyor type displacement of the droplet by favoring a direction of motion caused by the geometry of said half rounded structures. Said motion being directed towards the conduit openings and/or generally being directed along the pressure gradient them present in the conduits.

It is noted that all above described embodiments aim to solve the same technical problem and the solutions of said embodiments can be structurally and functionally combined. The combined effect is more than the mere sum of the single effects, because the solutions complement each other. Thus, every combination may result in a further embodiment. The main combinations are described in the detail below.

### BRIEF DESCRIPTION OF THE DRAWINGS

In the drawings:

FIG. 1a shows a sectional drawing of printhead according to an embodiment of the invention;

FIG. 1b shows a perspective drawing of printhead according an embodiment of the invention;

FIG. 2a shows a nozzle plate of a 3D printhead according to an embodiment of the present invention;

FIG. 2b shows a material removal unit of a 3D printhead according to an embodiment of the present invention;

FIG. 3 shows the bottom surface of the conduit forming element according to an embodiment of the invention;

FIG. 4a shows the material removal unit according to an embodiment of the invention in a state after drop ejection;

FIG. 4b shows the material removal unit according to an embodiment of the invention in a state after drop ejection with material being removed;

FIG. 4c shows the material removal unit according to an embodiment of the invention in a state after drop ejection and after material removal;

FIG. 5a shows a sectional drawing of a second embodiment of the invention;

FIG. 5b shows a sectional drawing of a third embodiment of the invention;

FIG. 6a shows a sectional drawing of a fourth embodiment of the invention;

FIG. 6b shows a sectional drawing of the fourth embodiment of the invention;

FIG. 7 shows a critical nozzle flooding event; and

FIG. 8 shows a sectional drawing of a fifth embodiment of the invention.

### DETAILED DESCRIPTION OF THE DRAWINGS

In the following, embodiments of the present invention will be described. It is noted that some aspects of every described embodiment may also be found in some other embodiments unless otherwise stated or obvious to the skilled person. However, for increased intelligibility, each aspect will only be described in detail when first mentioned and any repeated description of the same aspect will be omitted.

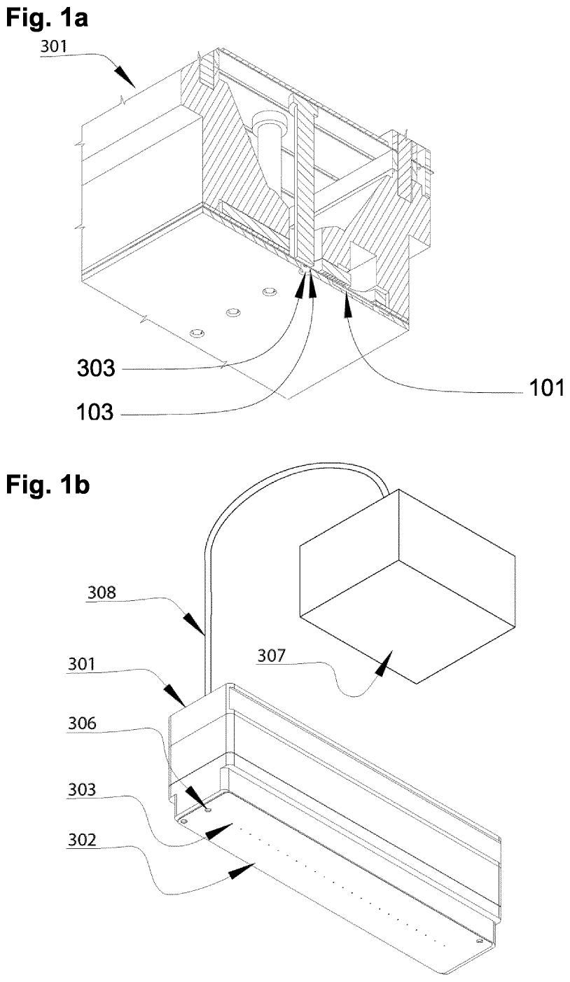

FIG. 1a shows a sectional perspective drawing of printhead according to an embodiment of the invention. FIG. 1b shows a perspective drawing of printhead according an embodiment of the invention.

The printhead 301 of FIG. 1a comprises a nozzle plate with a plurality of ejection orifices 303. A material removal unit, MRU, according to the invention comprises at least one pass-through opening 103 respectively arranged in correspondence with the at least one ejection orifices 303.

As discussed in the above referenced prior art document, the printhead may have a stacked architecture, i.e. it comprises a plurality of functional units stacked upon each other. In such an architecture the MRU is preferably located below the nozzle plate in a direction of the droplet ejection. The MRU is also be provided in form of a plate in the stacked architecture.

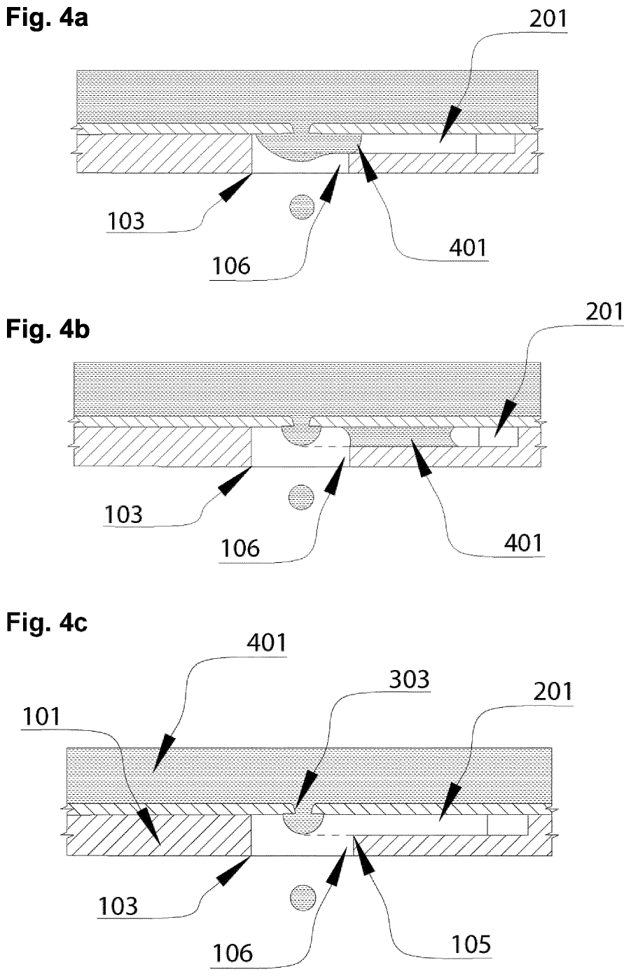

Furthermore, the printhead 301 as shown in FIG. 1b comprises a vacuum connector 306; a nozzle containing element 302, also referred to as nozzle plate, situated above the conduit forming element 101 of the MRU. The conduit forming element 101 is fastened to said nozzle containing element 302 and sealing said conduit forming channels 102 in order to create conduits 201, see FIGS. 4a to 4c.

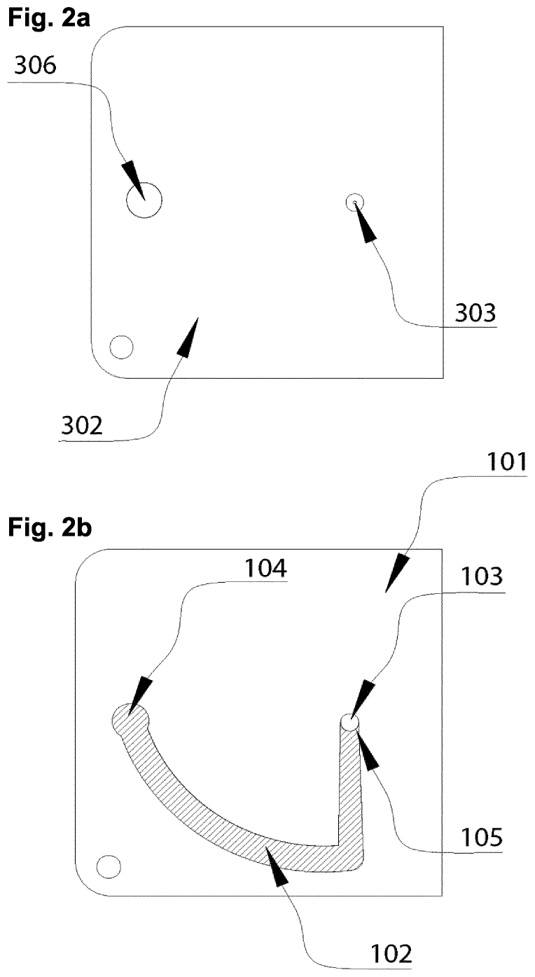

FIG. 2a shows a nozzle plate 302 of a 3D printhead according to an embodiment of the present invention. FIG. 2b shows a conduit forming element of a material removal unit according to an embodiment of the present invention. The nozzle plate 302 corresponds to the nozzle plate in FIG. 1b. The elements of the MRU in FIG. 2b positionally correspond to the elements of the nozzle plate 302 in FIG. 2a.

According to an embodiment of the invention, the material removal unit comprises: a conduit forming element 101 with at least one conduit forming channel 102, preferably forming a low-pressure material conduit. The conduit forming channel 102 is connecting at least one pass-through opening 103 and at least one low pressure connecting point 104. The MRU further preferably comprises at least one conduit opening 105 formed near said pass-through opening 103.

Now referring to FIG. 2a, the nozzle containing element 302 has at least one ejection orifice or nozzle 303, arranged in correspondence to said pass-through opening 103. The diameter of said ejection orifice 303 is preferably smaller than the diameter of the corresponding pass through opening 103, so that a droplet ejected from said nozzle is not affected by the pass-through opening.

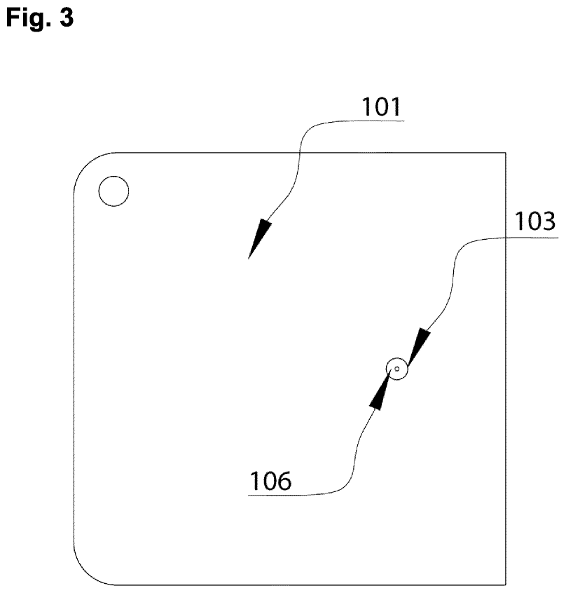

The area of the nozzle containing element 302 situated above the conduit forming element 101 and being positioned within the area of the pass-through opening 103 is also referred to as a nozzle well 106, see FIG. 3.

In an embodiment of the invention, the conduit forming element 101 is configured to be fastened to the nozzle containing element 302. Preferably, the fastening between the nozzle containing element 302 and the conduit forming element 101 is sealed. In a state when the conduit forming element 101 is fastened to the nozzle containing element the conduits 201, preferably low-pressure material conduits, are formed, see FIGS. 4a to 4c.

However, the invention is neither limited to closed conduits nor to the fastening on a nozzle containing element.

In alternative embodiments, at least one separate cover element may be provided, which is configured to close the at least one conduit 201 at least one side thereof. In other words, the cover element may be provided on top and/or below the conduit forming element and thus close the top and/or bottom of the formed conduits 201.

Furthermore, in an alternative embodiment, the conduits 201 are open at one side, preferably the bottom side (in the droplet ejection direction). The conduits 201 are still suitable for transport of a liquid material due to capillary effects and/or surface tension.

In an embodiment of the invention, the conduit 201 is connected to the low-pressure connecting point 104. The low-pressure connecting point 104 is configured to remove gas and liquid material 401 present within the conduit 201, preferably via a pressure gradient.

The pressure gradient is formed such that the gas and material is moved away from said conduit, preferably the conduit opening 105. In an embodiment of the invention, in order to obtain the pressure gradient, a vacuum pump is connected to the connection point 104. Preferably, the vacuum pump is connected to a vacuum connector 306 in the nozzle plate, i.e. connected to the low-pressure connecting point 104.

In other words, the use of a vacuum pump, allows for the transport of liquid material. In a preferred embodiment of the invention, the liquid material is transported via the vacuum tube 308 to the liquid material reservoir 307.

In an embodiment of the invention, the material reservoir is part of the printhead. In other words, the material removed by the MRU is transported, i.e. recycled, to the printhead and thus a material recovery unit is formed.

It is noted that the term vacuum is used in this description not only in its strict scientific meaning, but also in a broader more common technical meaning of a low-pressure or underpressurized condition.

In one embodiment of the invention, said liquid material reservoir 307 is configured to further transport the removed material to a waste container. Additionally or alternatively said reservoir is configured to further transport said material to a material cycling system, preferably located in the printhead.

FIG. 3 shows the bottom surface of the conduit forming element 101 according to an embodiment of the invention. That is, the opposite surface as shown in FIG. 2b. Only the pass-through opening 103 and the nozzle well 106 within said opening are visible.

FIG. 4a shows the material removal unit according to an embodiment of the invention in a state after drop ejection and a pendant droplet of excess material being formed. FIG. 4b shows the material removal unit according to an embodiment of the invention in a state after drop ejection with material being removed. FIG. 4c shows the material removal unit according to an embodiment of the invention in a state after drop ejection after material removal.

FIGS. 4a to 4c illustrate the material removal process according to an embodiment of the invention. The continuous restoration of material ejection properties in this case is performed by a removal of the excess material via the nozzle well 106.

In this embodiment, the geometry of the nozzle well 106 is utilized in order to allow for a path for a droplet 401 in excess of a certain size, i.e. threshold, to be guided to the conduit opening 105. In other words, as soon as the excess material 401 has a size similar to the size of the nozzle well 106, the droplet connects to or is attracted by the low-pressure conduit 201.

The conduit 201 is configured to suck in atmospheric gas via a negative pressure and said gas exhibiting a dragging force on the excess material 401 present in the nozzle well 106, thereby forcing it towards the conduit opening, cf. FIG. 4b.

In other words, the liquid printing material 401 may be ejected trough ejection orifice 303. The material may form pendent-drops upon ejection. The formation of a droplet may lead to excess material 401 forming in an area around the ejection orifice 303.

In an embodiment of the invention, as soon as the excess material reaches the first end of the conduit 201, it is transported into the conduit and subsequently transported in the conduit in a direction away from the first end towards the second end.

In an embodiment of the invention, the material ejection orifice is located at the center of the pass-through opening, allowing for uninhibited passage of intentionally ejected material, facilitated by the actuation of an actuating member by imparting a physical impulse onto the liquid material present in the printing head.

Said liquid material is forming a meniscus, or in other words, it is forming a liquid-gas interface at a position controlled by a negative internal pressure. The meniscus is formed in a position for ideal ejection under normal operation of said printhead.

Said meniscus has the potential to protrude downward until the gas liquid interface is no longer connected to the nozzle opening and causes a wetting of a surrounding surface around the nozzle, leading to a pendant drop formation of excess material.

This excess material is impeding the controlled release of droplets from the ejection orifice opening due to an interference of the ejected material and the excess material via surface tension and/or non-uniform kinetic energy transfer; thereby degrading printing performance.

Furthermore, a pendant drop of excess material can be formed in the area next to the nozzle and inside the nozzle well.

In an embodiment of the invention, the movement of the gas in the conduit 201 is caused by least one or more conduit openings 105 being connected to the vacuum pump, thereby creating a directional drag force across the entire nozzle well 106.

Said drag force causes the excess material to move towards the conduit openings 105 without any capillary forces necessary. Therefore, the pass through opening 103 can be large, in relation to a size at which capillary forces are relevant, and the ejection of large and small droplets from the same ejection orifice 303 becomes possible, without an ejected droplet touching the conduit forming element at the walls of the pass through opening.

In the above embodiment larger droplets are not negatively affected during the ejection by the MRU. The droplet volume of ejected material may range from 1 pl to 1300 pl. In other words, highly efficient printing modes are possible.

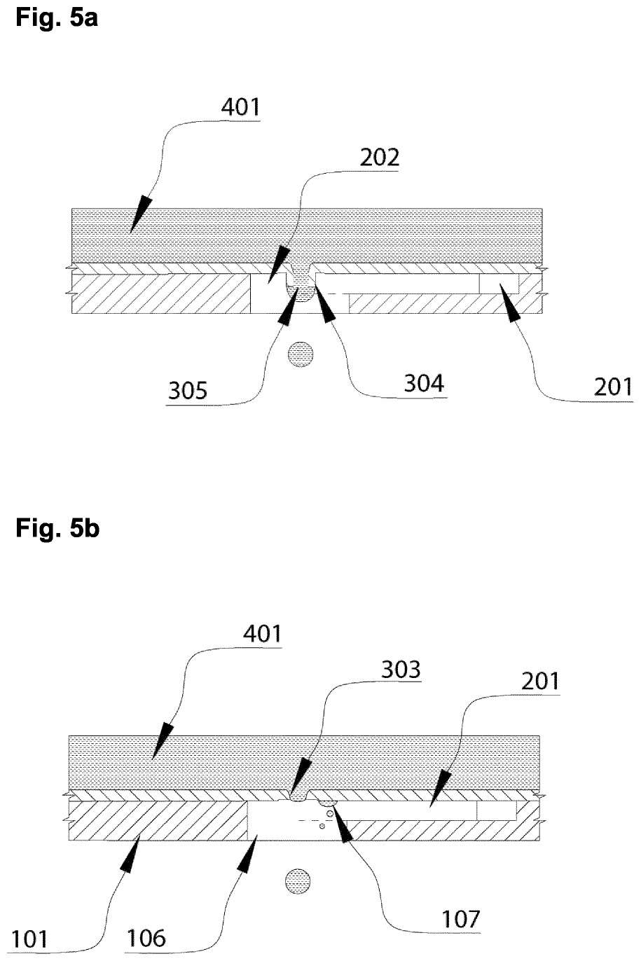

FIG. 5a shows a sectional drawing of a second embodiment of the invention. FIG. 5b shows a sectional drawing of a third embodiment of the invention.

In a second embodiment of the present invention, as shown in FIG. 5a, the ejection orifice 303 has a capillary elongation element 304 present around the nozzle configured to pass, at least partially, through the pass-through opening and forming an elevated ejection opening 305 with and a surrounding nozzle well 202.

The formation of said nozzle well 202 allows for an accumulation of excess liquid material therein. The excess liquid material 401 is moved away from said elevated ejection opening 305 through surface tension into said nozzle well 202. Furthermore, the formation of said nozzle well 202 allows for contact with at least one end of said low pressure material conduit 201, i.e. the conduit opening 105.

In a third embodiment of the present invention, as shown in FIG. 5b, the transport of material in the conduit is based on vibrations in the conduit 201. A pendant droplet of excess material has formed in close proximity to the nozzle opening 303.

It is a problem that vibrational energy in the nozzle containing element may causing the pendant droplet to expel material, thereby creating unwanted ejections during the printing process. In other words, under certain circumstances, a remnant vibrational energy, either originating from the internal actuator in the printhead or induced via a drag force, can vibrate the surface area of said pendant drop 107 next to the nozzle opening 303 and can lead to droplets being expelled from said pendant drop. Such droplets can have a sufficient volume to negatively impact the printing performance.

This state is especially relevant, when the rheological properties of the liquid material present in the printhead are not ideal; or in case of a high surface wetting; or for materials that exhibit properties that are non-Newtonian; or experience certain shear stresses or temperatures; or contain solid particles or elements, which influence the surface tension and density; or materials that have elastic properties at high shear rates. This is especially the case with highly viscous and novel or advanced materials or materials in different developmental stages, or with a significant degree in production related batch-variation affecting its property.

Furthermore, a continuous material transport may be hindered by liquid gas phases, trapping gas in such a way that liquid material is left in the conduit and/or decreases the vacuum gradient to such an extent, that material movement is hindered.

The third embodiment uses said vibrational energy as an advantage to remove the material and transport the material in the conduit.

According to the third embodiment of the invention, the material transport is aided by a vibration-based delivery method and/or via a complete or a micro-structured partial anti-stiction coating (e.g., FOTS, PTFE) on the nozzle containing element.

As described above, in a preferred embodiment the nozzle containing element forms the top wall of the conduit. However, the top wall may also be formed by another element such as a cover element or the conduit forming element. In the latter embodiments the vibration-based delivery method and/or a complete or a micro-structured partial anti-stiction coating (e.g., FOTS, PTFE) is provided on said top wall.

In an embodiment of the invention, the coating is applied in correspondence to the low-pressure material conduit forming channels and within said conduit forming channels, essentially creating an anisotropic ratchet conveyor on the bottom and/or top of said conduits.

Vertical vibrations of the nozzle containing element are transferred to the conduit forming element. The vibrations are preferably produced as a byproduct of the actuation of the internal mechanism, which is in fluid communication with the nozzle containing element.

According to an embodiment of the invention, the vibrations are passively utilized in order to facilitate a directional displacement of the material in the conduit. The displacement is caused by a ratchet conveyor mechanism based on the surface tension of the material present in the conduit at the liquid-gas interface.

The oscillations of the nozzle containing element in relation to the material present in the conduits and the conduit forming element cause the liquid-gas interface edge to be displaced and thus causing a wetting of a new area.

The micro-structuring allows for a pinning effect of the gas liquid interface on the areas of greater liquid contact, which do not have an anti-stiction coating in the ratchet style system. This allows the material front to move along said ratchet system and a trailing edge of the material to preferably stay in contact with the bulk material, which through surface tension eventually follows and thereby displacing the liquid material along a preferred direction.

This ratchet style system aids in the movement along said vacuum gradient, reducing hindered material transport. It is noted that the ratchet style system is compatible with any other embodiment of the invention as a primary and/or secondary transport mechanism.

In one embodiment of the invention, the anti-stiction coating is in the shape of curved rungs on the surface of the nozzle plate, i.e. top surface of the conduit. Additionally or alternatively the anti-stiction coating is in correspondence to the low-pressure material conduit forming channels and within said conduit forming channels. That is, the anti-stiction coating is essentially creating an anisotropic ratchet conveyor on the bottom and/or top of said conduits.

In a further embodiment of the invention, the nozzle containing element 302 is configured to have at least a first surface energy in one portion near to the ejection orifice 303; and the nozzle containing element 302 is further configured to have at least a second surface energy different from the first surface energy at a position adjacent to said first surface energy portion.

Preferably the areas with different surface energies are located in the nozzle well and along the formed conduits. Said areas of different surface energy being geometrically structured in a half-rounded shape.

This structure facilitates an excess accumulation of material present around said ejection orifice to be transported in a first direction, essentially perpendicular to the liquid material ejection direction, via the process called ratchet conveyoring, as described above.

The transport process is facilitated via the remnant vibrational energy, exerted on the underside of said nozzle containing element. Preferably the vibration is created by the actuation force of an actuator present inside the inkjet printhead.

The first direction leading from said ejection orifice towards a low-pressure material conduit opening, whereby material in direct contact with said opening is essentially transported away from said ejection orifice via suction.

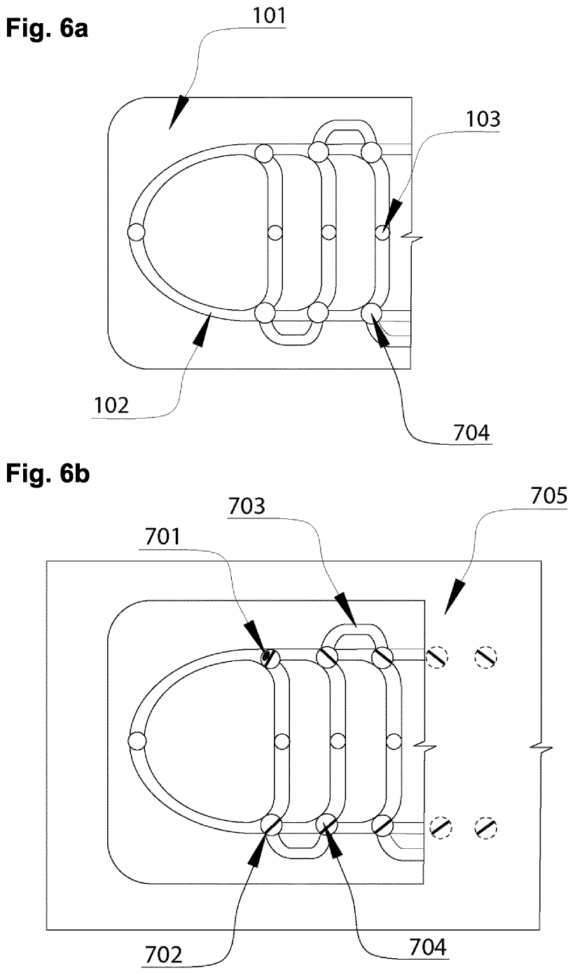

In FIGS. 6a and 6b a fourth embodiment of the invention is shown. In this embodiment the conduit forming element 101 comprises additional through openings 704 at junction points of the conduit forming channels 102. The underside of said conduit forming element 101 is positioned on top of a resting element 705 with elongated conduit shaping elements 702.

The conduit shaping elements 702 are inserted into the underside of said conduit forming element 101 and are essentially aligned with the through openings 704. The conduit shaping elements 702 are passing through said through openings, in order to reshape the conduits in the conduit forming element and in order to close off the through openings towards the underside of the conduit forming element.

In this embodiment, the conduits form an interconnected network, with multiple connection points for each element. When the elongated conduit shaping elements 702 are not inserted into the through openings, the conduits are further forming a single continuous fluid conduit through the use of redirecting conduits 703.

When the elongated conduit shaping elements 702 are inserted into said through openings a direct connection to a vacuum connector 701 can be obtained via an suitable inlet connector (not shown), in order to increase a pressure differential in a specific continuous fluid conduit thereby allowing remnant material to be cleaned much more effectively.

This embodiment is particularly suitable for applications with fast drying, aqueous and/or solvent based inks/suspensions.

The above described inlet connector is preferably configured to deliver a vapor or a liquid into the single continuous fluid conduit.

With regard to the embodiment shown in FIGS. 6a and 6b the removal of additional material present in the interconnected conduit system, that cannot be readily removed with the maximum pressure differential in said interconnected conduit system, may be a problem. The reshaping of said conduits, essentially transforming a network with multiple connections into a single connected conduit, enables a much greater concentration of negative pressure on one end of said singular conduit, thereby increasing the pressure differential until remnant material can be removed effectively. Furthermore, in this configuration a cleaning fluid may be introduced in order to wash away excess and hard to remove material in said singular conduit.

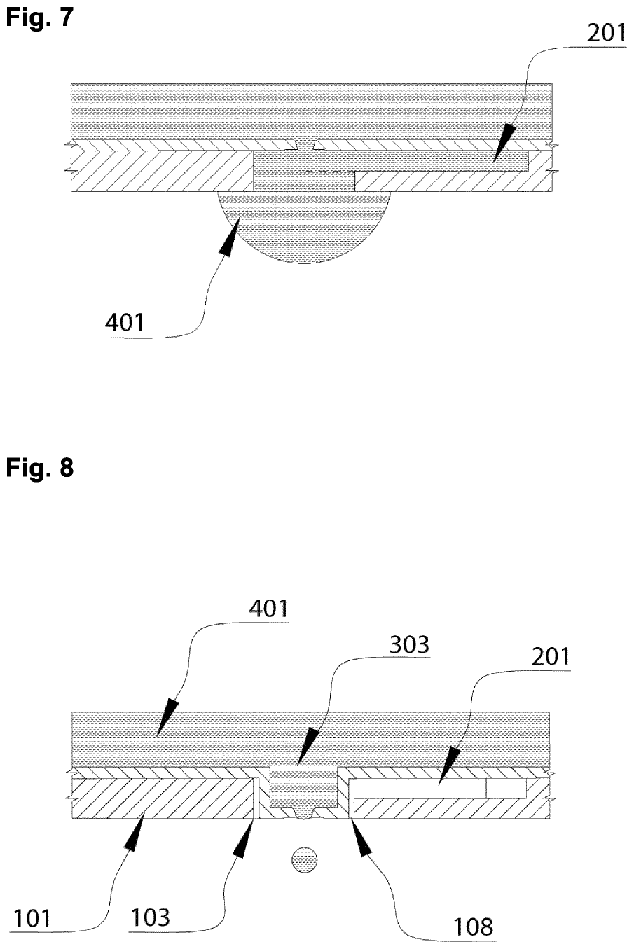

In FIG. 7 a critical nozzle flooding event is shown. In the nozzle flooding event occurs, impeding the ejection of liquid material, due to the presence of a large pendant drop of excess material 401, which has not been removed. The low-pressure conduit 201 has not created a large enough pressure differential with relation to the ambient pressure and/or dragging force in order to remove said excess material.

FIG. 8 shows a sectional drawing of a fifth embodiment of the invention. In the fifth embodiment of the invention, the lower surface of the nozzle containing element is extended within the area of the nozzle well in such a fashion as to be essentially at a same height as the lower surface of the conduit forming element. In such an arrangement the conduit openings 105 are essentially adjacent to the extended nozzle well and further connecting to said conduit 201 from the lower surface of said conduit forming element.

In this configuration secondary openings (108) are defined between the extended nozzle containing element and the pass-through opening 103, in close proximity to the nozzle opening. The secondary openings allow for removal of excess material. Once a pendant droplet has reached a sufficient size and essentially covers one or multiple secondary openings, the material is removed through the secondary opening.

The problem addressed the above embodiment of the invention, relates to the access of the lower surface of the nozzle containing element with cleaning elements such as wipers and other external systems to aid in removing material from the nozzle well area, when a transport of excess material cannot otherwise be facilitated. This embodiment thereby allows for a more effective removal of material that has been solidified and/or is otherwise impossible to remove within the confines of the other embodiments of the invention mentioned hereinabove. What has been described and illustrated hereinabove are embodiments of the invention along with some of variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

1. A material removal unit for a printhead, the unit comprising:
a pass-through opening provided under an ejection opening of the printhead and configured such that an ejected droplet can pass through the pass-through opening essentially without being affected;
at least one conduit forming channel configured to form a conduit;
wherein the conduit is communicatively connecting an area surrounding the ejection opening with a connection point configured to remove excess material from the area surrounding the ejection opening;
wherein the conduit has at least one conduit opening close to the pass-through opening and is configured to transport the material to the connection point.

2. The material removal unit according to claim 1,
wherein the conduit is
configured to be connected to a suction device at the connection point;
configured to remove the excess material from the area surrounding the ejection opening; and
configured to transport the material in the conduit through a dragging force; or
wherein a pressure gradient is formed in the conduit when the suction device is connected to the connection point.

3. The material removal unit according to claim 1,
wherein the conduit is
configured to be connected to a suction device at the connection point;
configured to remove the excess material from the area surrounding the ejection opening; and
configured to transport the material in the conduit through a dragging force; and
wherein a pressure gradient is formed in the conduit when the suction device is connected to the connection point.

4. The material removal unit according to claim 1,
wherein the diameter of the pass-through opening is at least essentially equal to a diameter of the corresponding ejection opening of the printhead.

5. The material removal unit according to claim 1,
wherein the diameter of the pass-through opening is at least essentially equal or greater that a diameter of the corresponding ejection opening of the printhead, and
wherein the ejection opening is located essentially in the center of the pass-through opening.

6. The material removal unit according to claim 1,
wherein the conduit is configured to transport the excess material to a material reservoir; or
wherein a material reservoir is in communication with the printhead in order to recycle the material in the material reservoir.

7. The material removal unit according to claim 1,
wherein the conduit is configured to transport the excess material to a material reservoir; and
wherein a material reservoir is in communication with the printhead in order to recycle the material in the material reservoir.

8. The material removal unit according to claim 1,
wherein a nozzle well is formed in the area surrounding the ejection opening; and
wherein the nozzle well is configured to allow a path for material in excess of a predetermined size threshold to be guided to the conduit opening.

9. The material removal unit according to claim 1,
wherein an anti-stiction coating is provided in the conduit and/or the area surrounding the ejection opening.

10. The material removal unit according to claim 1,
wherein the anti-stiction coating is a complete or a micro-structured partial anti-stiction coating.

11. The material removal unit according to claim 9,
wherein the anti-stiction coated area is configured to creating an anisotropic ratchet conveyor on the bottom and/or top of the conduit;
wherein the conduit is configured to support the ratchet conveyor by vibrations of the printhead; or
wherein the anti-stiction coating is provided in the shape of curved rungs.

12. The material removal unit according to claim 9,
wherein the anti-stiction coated area is configured to creating an anisotropic ratchet conveyor on the bottom and/or top of the conduit;
wherein the conduit is configured to support the ratchet conveyor by vibrations of the printhead; and
wherein the anti-stiction coating is provided in the shape of curved rungs.

13. The material removal unit according to claim 1,
wherein at least two areas with different surface energies are provided around the ejection opening in a half-rounded shape.

14. The material removal unit according to claim 1,
wherein additional openings are provided at junction points of the conduit forming channels; and
wherein conduit shaping elements are provided in said openings in order to reshape of the conduits formed in the conduit forming element.

15. A material removal method for a printhead, the method comprising:
providing a material removal unit according to claim 1;
communicatively connecting, with a conduit, an area surrounding the ejection opening with a connection point configured to remove excess material from the area surrounding the ejection opening; and
transporting the excess material to the connection point based on at least one transport method;
wherein the conduit has at least one conduit opening close to the pass-through opening.

16. The material removal method for a printhead according to claim 15,
wherein the transport method is based on a pressure gradient in the conduit; or
based on a ratchet conveyor in the conduit and/or a nozzle well.

17. The material removal method for a printhead according to claim 15,
wherein the transport method is based on a pressure gradient in the conduit; and
based on a ratchet conveyor in the conduit and/or a nozzle well.

18. The material removal unit according to claim 1, wherein the diameter of the pass-through opening is greater than a diameter of the corresponding ejection opening of the printhead.

19. The material removal unit according to claim 1, wherein the ejection opening is located essentially in the center of the pass-through opening.
